(19) United States
(12) Patent Application Publication
(10) Pub. No.: US 2021/0194787 A1
(43) Pub. Date: Jun. 24, 2021

(54) NETWORK DEVICE, NOTIFICATION METHOD, AND NON-TRANSITORY COMPUTER READABLE MEDIUM STORING NOTIFICATION PROGRAM

(71) Applicant: NEC Corporation, Tokyo (JP)

(72) Inventor: Shunichiro ABE, Tokyo (JP)

(73) Assignee: NEC Corporation, Tokyo (JP)

(21) Appl. No.: 17/118,871

(22) Filed: Dec. 11, 2020

(30) Foreign Application Priority Data
Dec. 18, 2019 (JP) 2019-228095

(51) Int. Cl. H04L 12/26; H04L 12/42

(52) U.S. Cl. CPC H04L 43/0888; H04L 12/42

(57) ABSTRACT

Each of network devices 10b to 10d calculate a data reception speed of own node, based on an amount of data per unit time received from an adjacent node in a ring network 30. Each of the network devices 10b to 10d writes the data reception speed of the node in the frame when the monitoring unit receives the frame. The data reception speed of another node in the ring network including the adjacent node may be written in this frame. Next, each of the network devices 10b to 10d selects the data reception speed to be notified from among the data reception speeds written in the frame, in which the data reception speed of the node is write, and transmits information indicating the data reception speed to a notification destination node outside the ring network 30.

### INCORPORATION BY REFERENCE

This application is based upon and claims the benefit of priority from Japanese patent application No. 2019-228095, filed on Dec. 18, 2019, the disclosure of which is incorporated herein in its entirety by reference.

### TECHNICAL FIELD

The present disclosure relates to a network device, a notification method, and a non-transitory computer readable medium storing a notification program. In particular, the present disclosure relates to a network device, a notification method, and a non-transitory computer readable medium storing a notification program for notifying a speed of a link in a ring network.

### BACKGROUND ART

A ring network constructed in compliance with Ethernet (registered trademark) has been used in a mobile backhaul. In the ring network, by setting a blocking port (BP) to a specific node in the ring network in accordance with ERPS (Ethernet Ring Protection Switching-ITU-T G. 8032), data communication in an RPL (Ring Protection Link) is cut off, so that a loop of communication data in the ring network can be prevented. When a failure occurs in a link in the ring network, a blocking port is set to avoid the failed link and a communication path is reconfigured, thereby enabling continuous data communication in the ring network.

In this regard, the RPL determination method disclosed in International Patent Publication No. WO 2017/159142 determines an RPL that maximizes the speed of a link in a ring network when the speed of a wireless link in the ring network changes due to an influence of an external environment.

### SUMMARY

However, since the RPL determination method disclosed in International Patent Publication No. WO 2017/159142 is a technique for determining the RPL that maximizes the speed of the link in the ring network, there has been a problem that the speed of the link in the ring network cannot be notified to a device outside the ring network.

In view of the foregoing problems, an example object of the present disclosure is to provide a network device, a notification method, and a non-transitory computer readable medium storing a notification program capable of notifying a speed of a link in a ring network to a device outside a ring network.

An example aspect of the present disclosure is a network device including:

a reception speed calculation unit configured to calculate a data reception speed of own node, the own node being the network device, based on an amount of data per unit time received from an adjacent node in a ring network;

a monitoring unit configured to monitor whether or not a frame has been received, at least one data reception speed of another node in the ring network including the adjacent node possibly being written in the frame;

a writing unit configured to write the data reception speed of the own node calculated by the reception speed calculation unit in the frame when the monitoring unit receives the frame;

a selection unit configured to select the data reception speed to be notified from among the data reception speeds written in the frame based on a selection rule for selecting the data reception speed to be notified, the data reception speed of the own node being written in the frame; and

a transmission unit configured to transmit information indicating the data reception speed selected by the selection unit to a notification destination node outside the ring network.

Another example embodiment of the present disclosure is a notification method including:

calculating a data reception speed of own node, the own node being the network device, based on an amount of data per unit time received from an adjacent node in a ring network;

monitoring whether or not a frame has been received, at least one data reception speed of another node in the ring network including the adjacent node possibly being written in the frame;

writing the calculated data reception speed of the own node in the frame when the frame is received;

selecting the data reception speed to be notified from among the data reception speeds written in the frame based on a selection rule for selecting the data reception speed to be notified, the data reception speed of the own node being written in the frame; and

transmitting information indicating the selected data reception speed to a notification destination node outside the ring network.

Another example aspect of the present disclosure is a non-transitory computer readable medium storing a notification program causing a network device to execute the following steps of:

calculating a data reception speed of own node, the own node being the network device, based on an amount of data per unit time received from an adjacent node in a ring network;

monitoring whether or not a frame has been received, at least one data reception speed of another node in the ring network including the adjacent node possibly being written in the frame;

writing the calculated data reception speed of the own node in the frame when the frame is received;

selecting the data reception speed to be notified from among the data reception speeds written in the frame based on a selection rule for selecting the data reception speed to be notified, the data reception speed of the own node being written in the frame; and transmitting information indicating the selected data reception speed to a notification destination node outside the ring network.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is an overview diagram showing a network system according to an example embodiment of the present disclosure;

FIG. 2 is a block diagram showing a configuration of a network device according to the example embodiment of the present disclosure;

FIG. 3 is a block diagram showing main components of the network device according to the example embodiment of the present disclosure;

FIG. 4 is a diagram showing an example of a ring frame; and

FIG. 5 is a flowchart showing processing executed by the network device according to the example embodiment of the present disclosure.

### EMBODIMENTS

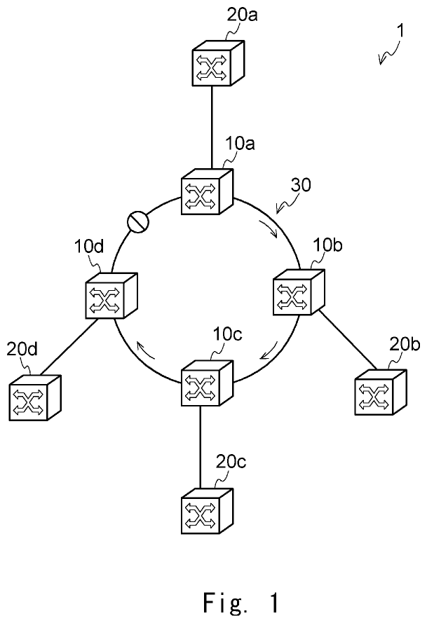

Hereinafter, an example embodiment of the present disclosure will be described with reference to the drawings. FIG. 1 is an overview diagram showing a network system 1 according to an example embodiment of the present disclosure. The network system 1 includes network devices 10a to 10d connected to a ring network 30 and network devices 20a to 20d connected to a network other than the ring network 30. These network devices correspond to nodes in the network system 1.

The ring network 30 is constructed in compliance with Ethernet. Each of the network devices 10a to 10d and network devices 20a to 20d may communicate data with adjacent nodes in a wired or wireless manner. Although only eight network devices 10a to 10d and 20a to 20d are shown in FIG. 1 for convenience of explanation, the network system 1 may include any number of network devices.

The network devices 10a to 10d relay data received from adjacent nodes to other adjacent nodes. Specific examples of the network devices 10a to 10d include devices such as routers that relay data. The network device 10a periodically transmits a communication frame (hereinafter referred to as a “ring frame”) to be transferred inside the ring network 30 to the adjacent node in the ring network 30. Hereinafter, the network device as a transmission source of the ring frame is defined as an owner node. Identification information of the owner node is written in the ring frame transmitted by the owner node. In this example embodiment, for example, an R-APS (Ring-Automatic Protection Switching) frame of the ERPS can be extended and used as the ring frame.

Each of the network devices 10b to 10d writes information indicating a data reception speed of own node in the ring frame received from the adjacent node in the ring network 30, and transmits the ring frame to the other adjacent node in the ring network 30.

In the example shown in FIG. 1, since a link between the network device 10a and the network device 10d is set as the RPL, data communication between the network device 10a and the network device 10d is cut off. In this case, the network device 10a, which is the owner node, transmits the ring frame to the network device 10b, which is the adjacent node, via a link not set as the RPL, i.e., a link between the network device 10a and the network device 10b. In the example shown in FIG. 1, the ring frame is transferred from the network device 10a to the network device 10b, the network device 10c, and the network device 10d.

The link between the owner node and the adjacent node is usually set as the RPL, and thus the owner node transmits one ring frame to another adjacent node. Each node writes the information indicating the data reception speed of own node in one received ring frame and transfers the ring frame. By doing so, one ring frame can be used to share the information indicating the data reception speed, i.e., the link speed, of more nodes in the ring network 30.

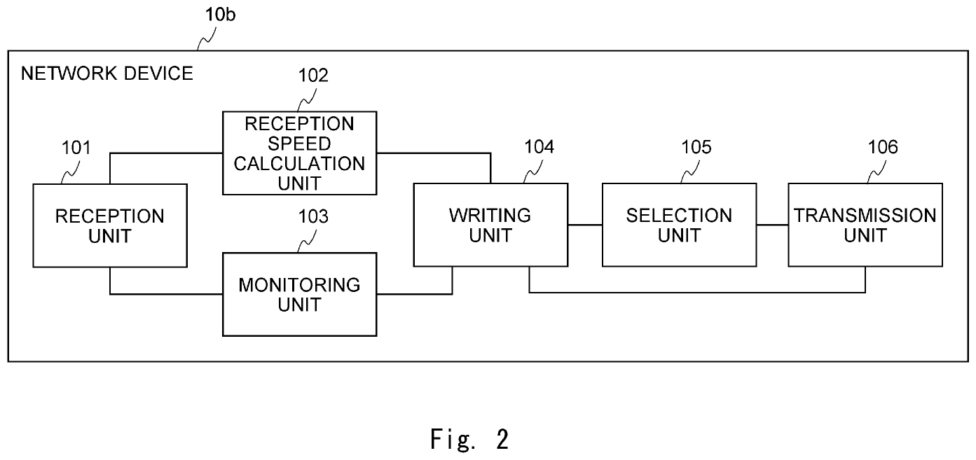

The network devices 10b to 10d select the data reception speeds to be notified from the data reception speeds written in the ring frames based on a selection rule for selecting the data reception speed to be notified. The network devices 10b to 10d then transmit information indicating the selected data reception speed to a notification destination node outside the ring network 30. Details of the functions of the network devices 10b to 10d will be described later with reference to FIG. 2.

The network devices 20a to 20d are connected to the network other than the ring network 30. The network devices 20a to 20d may be upper or lower nodes of the network devices 10a to 10d. The network devices 20a to 20d can be notification destination nodes of the information indicating the data reception speed to be notified.

FIG. 2 is a block diagram showing a configuration of the network device 10b according to the example embodiment of the present disclosure. The configuration of the network device 10b will be described below. The network devices 10c and 10d have the same configuration as that of the network device 10b.

The network device 10b includes an arithmetic device (not shown) such as a CPU (Central Processing Unit), and an MPU (Micro Processing Unit), and a storage device (not shown) storing a notification program according to the example embodiment of the present disclosure. The arithmetic device can implement the functions of the network device 10b by reading out the notification program from the storage device and executing it. An integrated circuit such as an FPGA (Field-Programmable Gate Array) or an ASIC (Application Specific Integrated Circuit) may be used to implement these functions. These arithmetic devices and integrated circuits correspond to computers.

The network device 10b includes a reception unit 101, a reception speed calculation unit 102, a monitoring unit 103, a writing unit 104, a selection unit 105, and a transmission unit 106. The reception unit 101 is an interface for receiving data from the adjacent node. The data received by the reception unit 101 includes the ring frame transmitted by the owner node. When there is at least one node between the owner node and the own node, the data reception speed of the one node is written in the ring frame received by the reception unit 101. When there is no other node between the owner node and the own node, the data reception speed of any node in the ring network 30 is not written in the ring frame.

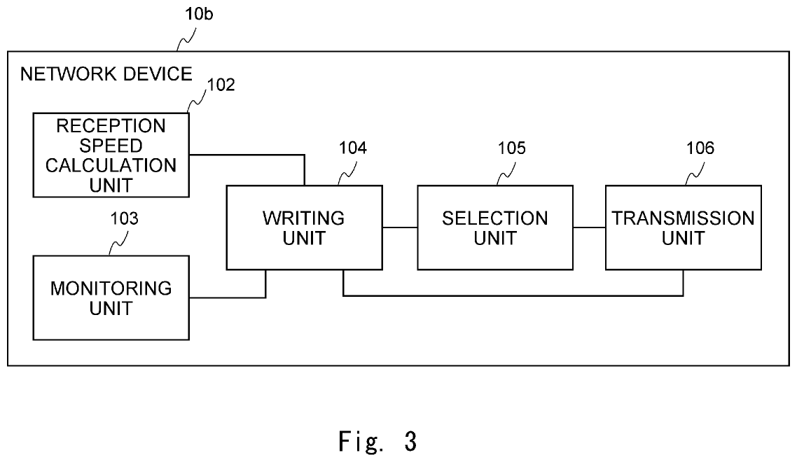

FIG. 3 is a block diagram showing main components of the network device 10b according to the example embodiment of the present disclosure. The network device 10b includes the reception speed calculation unit 102, the monitoring unit 103, the writing unit 104, the selection unit 105, and the transmission unit 106.

The reception speed calculation unit 102 is a functional unit that calculates the data reception speed based on an amount of data per unit time received from the adjacent node of the ring network 30. The data reception speed is equivalent to the speed of the link between the adjacent node and the own node, i.e., a bandwidth of the link. The reception speed calculation unit 102 calculates the data reception speed when the reception unit 101 receives data from the adjacent node, and provides the information indicating the calculated data reception speed to the writing unit 104.

The monitoring unit 103 is a functional unit that determines whether or not the reception unit 101 has received the ring frame from the adjacent node in the ring network 30. When the monitoring unit 103 receives the ring frame, the monitoring unit 103 provides the ring frame to the writing unit 104.

The writing unit 104 is a functional unit that writes the identification information of the network device 10b and the data reception speed in the ring frame. The data reception speed written in the ring frame includes a theoretical maximum and minimum values of the data reception speed corresponding to a nominal bandwidth, and the maximum and minimum values of the data reception speed calculated by the reception speed calculation unit 102, i.e., the maximum and minimum values of the actual data reception speed.

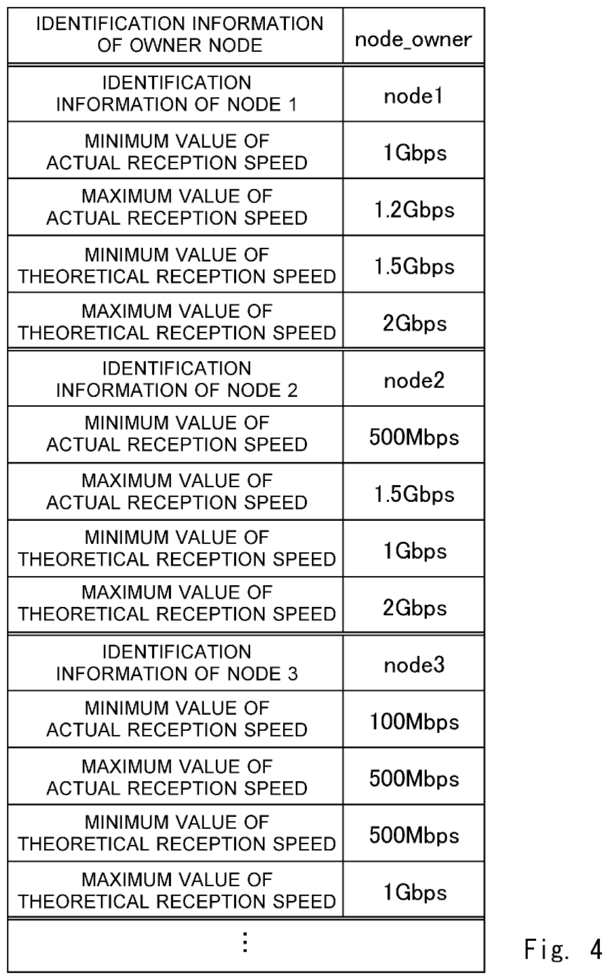

FIG. 4 is a diagram showing an example of the data written in the ring frame. The ring frame includes the identification information of the owner node, the identification information of the nodes in the ring network 30, and the data reception speeds of the nodes. The writing unit 104 provides the ring frame in which the information is written to the selection unit 105 and the transmission unit 106.

The selection unit 105 is a functional unit that selects the data reception speed to be notified from among data reception speeds written in the ring frame based on the selection rule for selecting the data reception speed to be notified. The selection rule may specify, for example, a rule for selecting at least one of the maximum value and the minimum value of the actual data reception speed written in the ring frame. The selection rule can specify at least one of the maximum value and the minimum value of the actual data reception speed from a specific node of the ring network 30, to which the network device 10b is connected, to the own node. The specific node may be, for example, a node connected to a node outside the ring network 30.

When the selection unit 105 selects the data reception speed based on the selection rule, the selection unit 105 writes the selected data reception speed in a notification frame and provides the notification frame to the transmission unit 106. The notification frame is for notifying the notification destination node outside the ring network 30 of the data reception speed. In this example embodiment, the communication frame used in the ETH-BN (Ethernet Bandwidth Notification) may be employed as the notification frame.

The transmission unit 106 is an interface for transmitting the communication frame provided from the writing unit 104 and the selection unit 105 to another node. Specifically, the transmission unit 106 transmits the ring frame provided by the writing unit 104 to the adjacent node other than the adjacent node to which the ring frame has been transmitted, namely, to another adjacent node in the ring network 30. The transmission unit 106 transmits the notification frame provided by the selection unit 105, i.e., the notification frame in which the information indicating the data reception speed selected by the selection unit 105 is written, to the notification destination node outside the ring network 30.

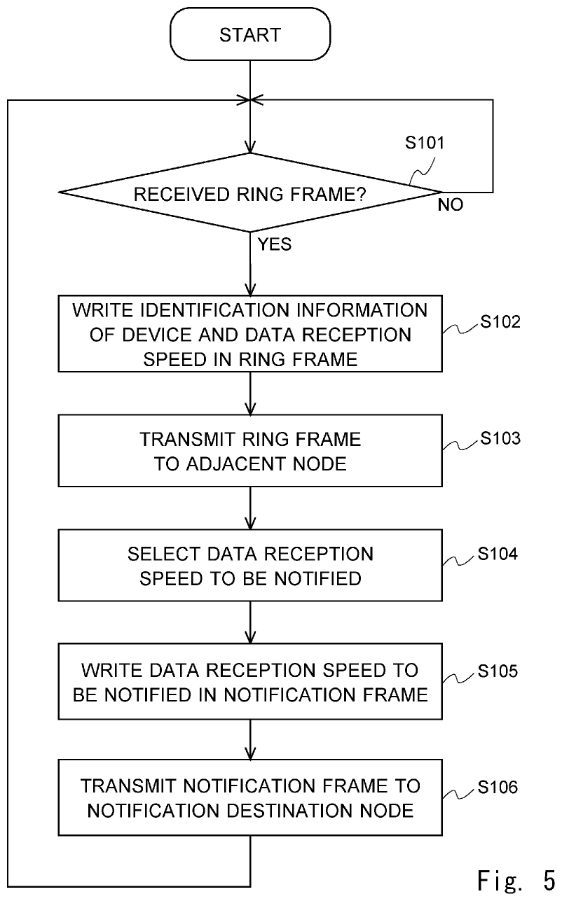

FIG. 5 is a flowchart showing an example of processing executed by the network devices 10b to 10d. Hereinafter, a case where the network device 10b executes the processing will be described. In Step S101, the monitoring unit 103 of the network device 10b determines whether or not the ring frame has been received. If no ring frame has been received (NO), the process of Step S101 is executed again. On the other hand, when the ring frame is received (YES), the process branches to Step S102.

In Step S102, the writing unit 104 writes the identification information of the network device 10b, the maximum and minimum values of the theoretical data reception speed, and the maximum and minimum values of the actual data reception speed in the ring frame. In Step S103, the transmission unit 106 transmits the ring frame, in which the above-mentioned pieces of information are written, to the adjacent node other than the adjacent node that has transmitted the ring frame.

In Step S104, the selection unit 105 selects, based on the selection rule, the data reception speed to be notified from among the data reception speeds written in the ring frame. In the ring frame, the identification information and the data reception speed of the network device 10b are written in Step S102. In Step S105, the selection unit 105 writes the data reception speed to be notified selected in Step S104 in the notification frame. In Step S106, the transmission unit 106 transmits the notification frame, in which the data reception speed to be notified is written, to the notification destination node.

In the above-described example embodiment, when each of the monitoring units 10b to 10d of the network device 103 determines that the ring frame has been received, the writing unit 104 writes the data reception speed of the own node calculated by the reception speed calculation unit 102 in the ring frame. Then, the selection unit 105 selects the data reception speed to be notified from among the data reception speeds written in the ring frame based on the selection rule, and writes the information indicating the data reception speed in the notification frame. Then, the transmission unit 106 transmits the notification frame to the notification destination node outside the ring network 30.

Thus, each of the network devices 10b to 10d can notify the speed of the link in the ring network 30 selected based on the selection rule to the device outside the ring network 30. This is particularly useful when the ring network 30 includes a wireless link. Since the wireless link transmits information using radio waves as a medium, it is more susceptible to the influence of external environments such as temperature and weather, and the link speed is more likely to vary, as compared with the wired link. The influence of the external environments on the speed of the wireless link in the ring network 30 can be acquired by notifying the communication destination node of the speed of the link of the ring network 30 including the wireless link having such a characteristic.

As described above, the data reception speed of another node present between the owner node, which is the transmission source of the ring frame, and the own node is written in the ring frame received by each of the network devices 10b to 10d. Each of the network devices 10b to 10d selects the data reception speed to be notified from among the data reception speed of the other node and the data reception speed of the own node, and notifies the selected data reception speed to the notification destination node.

For example, in the example shown in FIG. 1, assume that the actual minimum value of the speed of the link between the network device 10a and the network device 10b is 1 Gbps, the actual minimum value of the speed of the link between the network device 10b and the network device 10c is 500 Mbps, and the actual minimum value of the speed of the link between the network device 10c and the network device 10d is 100 Mbps. In this case, when the selection rule specifies that the minimum value of the data reception speed is to be selected, the network device 10b notifies the notification destination node of the actual minimum value of the speed of the link (1 Gbps). The network device 10c notifies the notification destination node of the actual minimum value (500 Mbps) of the speed of the link. The network device 10d notifies the notification destination node of the actual minimum value (100 Mbps) of the speed of the link. In this way, each of the network devices 10b to 10d can notify the speed of the link between the owner node and the own node among a plurality of links in the ring network 30.

In the above-described example embodiment, each of the network devices 10b to 10d in the ring network 30 other than the owner node notifies the notification destination node of the link speed. By doing so, the amount of data communication can be reduced in comparison with a configuration in which all the network devices 10a to 10d in the ring network 30 including the owner node notify the notification destination node of the link speed. Thus, the processing load and the memory usage in the notification destination node can be reduced.

Furthermore, in the example embodiment described above, each of the network devices 10b to 10d may notify the notification destination node outside the ring network 30 of the selected one of the maximum and minimum values, instead of notifying the maximum and minimum values of the plurality of link speeds in the ring network 30. In this way, the notification destination node can manage the ring network 30 composed of the plurality of links as a single link instead of the plurality of links.

Further, in the above-described example embodiment, when the RPL in the ring network 30 is changed and the communication path in the ring network 30 is changed, the owner node transmits the ring frame along the changed communication path. Each of the network devices 10b to 10d writes the data reception speed of the own node in the ring frame and transfers the ring frame to another node in the same manner as that before the RPL is changed. Each of the network devices 10b to 10d selects the data reception speed to be notified from among the data reception speeds written in the ring frame and notifies the notification destination node of the data reception speed. Thus, even when the communication path in the ring network 30 is changed, the speed of the link in the ring network 30 can be notified to the device outside the ring network 30.

Further, when the selection rule specifies a selection of at least one of the maximum value and the minimum value of the actual data reception speed written in the ring frame, each of the network devices 10b to 10d selects at least one of the maximum value and the minimum value of the actual data reception speed written in the ring frame and notifies the notification destination node outside the ring network 30 of the selected one of the maximum value and the minimum value of the actual data reception speed. In this way, the notification destination node can acquire at least one of the maximum value and the minimum value, which is selected by each of the network devices 10b to 10d, of the actual speed of the link between the owner node and the own node.

Further, when the selection rule specifies a selection of at least one of the maximum value and the minimum value of the actual data reception speed from a specific node, which is connected to the node outside the ring network 30, in the ring network 30 to the own node, each of the network devices 10b to 10d selects at least one of the maximum value and the minimum value of the data reception speed from the specific node to the own node and notifies the notification destination node outside the ring network 30 of the selected one of the maximum value and the minimum value of the data reception speed from the specific node to the own node.

In this manner, at least one of the maximum value and the minimum value of the data reception speed from the specific node other than the owner node to the own node can be notified to the notification destination node. This is useful when the node outside the ring network 30 to which the specific node is connected is an upper node and the own node is connected to a lower node outside the ring network 30.

For example, in the network system 1 shown in FIG. 1, it is assumed that the network device 10d is the own node, the network device 20b is the upper node, and the network device 20d is the lower node. In this case, the data transmitted by the network device 20b is transferred to the network device 20d via the network device 10b, the network device 10c, and the network device 10d in the ring network 30. The network device 10d selects at least one of the maximum value and the minimum value of the data reception speed from the network device 10b, which corresponds to the specific node, to the own node and notifies the notification destination node of the selected one of the maximum value and the minimum value of the data reception speed. That is, the network device 10d does not select the speed of the link between the network device 10a and the network device 10b. Hence, the network device 10d can notify the speed of the link in the ring network 30 through which the data flowing from the upper node to the lower node via the node actually passes.

Further, the selection unit 105 writes the information indicating the selected data reception speed in the notification frame used by the ETH-BN, and the transmission unit 106 transmits the notification frame to the notification destination node. Thus, each network device 10b to 10d can notify the speed of the link in the ring network 30 to the device outside the ring network 30 using the function of the ETH-BN.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

In another example embodiment, when both a wireless link and a wired link are present in the ring network 30, each of the network devices 10b to 10d can select at least one of the maximum value and the minimum value of the data reception speed from the node forming the wireless link in the ring network 30 to the own node. Thus, each of the network devices 10b to 10d can notify the communication destination node of at least one of the maximum value and the minimum value of the data reception speed from the node forming the wireless link whose link speed is likely to vary to the own node.

In another example embodiment, each of the network devices 10b to 10d may select the data reception speed to be notified using a plurality of ring frames received from adjacent nodes in the ring network 30 at different timings. More specifically, the selection unit 105 can select the data reception speed to be notified using the plurality of ring frames for which a predetermined period has not elapsed since the reception. The predetermined period can be a representative value (e.g., mean and median values) of a period required for stabilization of the link speed when the link speed is reduced.

By doing so, for example, in the case of employing the selection rule for selecting the minimum value of the data reception speed, when the link speed of a certain link is reduced from 500 Mbps to 200 Mbps and then recovers from 200 Mbps to 500 Mbps, each of the network devices 10b to 10d notifies the notification destination node of the reduced link speed (200 Mbps) until the predetermined period elapses. After the predetermined period has elapsed, each of the network devices 10b to 10d notifies the notification destination node of the recovered link speed (500 Mbps). That is, even if the link speed is recovered after the link speed is reduced, each of the network devices 10b to 10d notifies the notification destination node of the reduced link speed until the predetermined period elapses, and notifies the notification destination node of the recovered link speed when the predetermined period elapses.

In a situation where the link speed is unstable, after the link speed is recovered, the link speed may be reduced again before the predetermined period elapses. Thus, in the configuration in which each of the network devices 10b to 10d selects the data reception speed to be notified using one latest ring frame received from the adjacent node, the notification destination node is notified of the link speed of the link right after the recovery. Thus, when the destination node selects a data transmission path based on the notified link speed, if the notification destination node selects the data transmission path based on the link speed of the link right after the recovery, the link speed in the selected transmission path is reduced again. This may cause the data communication speed to be reduced. Thus, the notification destination node cannot select a transmission path whose link speed is stable.

On the other hand, in a configuration in which each of the network devices 10b to 10d selects the data reception speed to be notified using a plurality of ring frames for which the predetermined period has not elapsed since the reception, the notification destination node is notified of the reduced link speed until the predetermined period elapses even after the link speed recovers. For this reason, the notification destination node can select another link whose link speed has not been reduced as the transmission path. It is thus possible to avoid a situation in which the data communication speed is reduced due to the link speed being reduced again in the transmission path selected by the notification destination node. Thus, the notification destination node can select a transmission path having a stable link speed.

According to the present disclosure, it is possible to provide a network device, a notification method, and a non-transitory storage medium storing a notification program capable of notifying a speed of a link in a ring network to a device outside the ring network.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A network device connected to a ring network comprising:
a reception speed calculation unit configured to calculate a data reception speed of own node, the own node being the network device, based on an amount of data per unit time received from an adjacent node in the ring network;
a monitoring unit configured to monitor whether or not a frame has been received, at least one data reception speed of another node in the ring network including the adjacent node possibly being written in the frame;
a writing unit configured to write the data reception speed of the own node calculated by the reception speed calculation unit in the frame when the monitoring unit receives the frame;
a selection unit configured to select the data reception speed to be notified from among the data reception speeds written in the frame based on a selection rule for selecting the data reception speed to be notified, the data reception speed of the own node being written in the frame; and
a transmission unit configured to transmit information indicating the data reception speed selected by the selection unit to a notification destination node outside the ring network.

2. The network device according to claim 1, wherein
the selection unit is configured to select at least one of a maximum value and a minimum value of an actual data reception speed written in the frame.

3. The network device according to claim 2, wherein
the selection unit is configured to select at least one of the maximum value and the minimum value of the actual data reception speed from a specific node to the own node in the ring network, and
the specific node is connected to a node outside the ring network.

4. The network device according to claim 1, wherein
the ring network is constructed in compliance with Ethernet (registered trademark),
the selection unit is configured to write information indicating the selected data reception speed in a notification frame used in ETH-BN (Ethernet Bandwidth Notification), and
the transmission unit is configured to transmit the notification frame to the notification destination node, information indicating the selected data reception speed being written in the notification frame.

5. The network device according to claim 1, wherein
the selection unit is configured to select the data reception speed to be notified using a plurality of the frames, a predetermined period has not elapsed since the reception of the plurality of frames.

6. A notification method comprising:
calculating a data reception speed of own node, the own node being the network device, based on an amount of data per unit time received from an adjacent node in a ring network;
monitoring whether or not a frame has been received, at least one data reception speed of another node in the ring network including the adjacent node possibly being written in the frame;
writing the calculated data reception speed of the own node in the frame when the frame is received;
selecting the data reception speed to be notified from among the data reception speeds written in the frame based on a selection rule for selecting the data reception speed to be notified, the data reception speed of the own node being written in the frame; and
transmitting information indicating the selected data reception speed to a notification destination node outside the ring network.

7. A non-transitory computer readable medium storing a notification program causing a network device to execute the following steps of:
calculating a data reception speed of own node, the own node being the network device, based on an amount of data per unit time received from an adjacent node in a ring network;
monitoring whether or not a frame has been received, at least one data reception speed of another node in the ring network including the adjacent node possibly being written in the frame;
writing the calculated data reception speed of the own node in the frame when the frame is received;
selecting the data reception speed to be notified from among the data reception speeds written in the frame based on a selection rule for selecting the data reception speed to be notified, the data reception speed of the own node being written in the frame; and
transmitting information indicating the selected data reception speed to a notification destination node outside the ring network.
